(19) United States
(12) Patent Application Publication
(10) Pub. No.: US 2026/0257199 A1
(43) Pub. Date: Sep. 3, 2026

(54) METHOD FOR PREPARING POROUS ADSORBENT PARTICLES, A POROUS ADSORBENT PARTICLE AND SAMPLING DEVICE, AND USE THEREOF

(71) Applicant: Imperial College Innovations Limited, LONDON (GB)

(72) Inventors: Roisin Anne O'CONNELL, LONDON (GB); William Nicholas SHARRATT, LONDON (GB); Joao Pedro Beija Tavares CABRAL, LONDON (GB); Nicolaas Johanna Jozef AELMANS, Apeldoorn (NL)

(21) Appl. No.: 18/994,451

(22) PCT Filed: Jul. 10, 2023
(86) PCT No.: PCT/EP2023/069021

§ 371 Date: Jan. 14, 2025

(30) Foreign Application Priority Data
Jul. 14, 2022 (GB) 2210380.8

(51) Int. Cl. B01J 20/26; B01J 20/28; B01J 20/30; G01N 1/22

(52) U.S. Cl. CPC B01J 20/262; B01J 20/28004; B01J 20/28019; B01J 20/28021; B01J 20/305; G01N 1/2214

(57) ABSTRACT

The present invention relates to a method for preparing porous adsorbent particles and to a porous adsorbent particle and a sampling device containing a plurality of said particles. The present invention also relates to the use of said particle or said sampling device.

The present invention relates to a method for preparing porous adsorbent particles. The present invention also relates to a porous adsorbent particle of poly(2, 6-diphenyl-p-phenylene oxide), and a sampling device containing a plurality of said particles. The present invention also relates to the use of said particles or said sampling device.

### INTRODUCTION

In order to ensure air quality, it is necessary to monitor the airborne presence and concentration of chemical compounds, in particular volatile organic compounds. Other reasons why it may be desirable to monitor the presence of airborne compounds may include detection of explosives, drugs or collection of samples for scientific purposes, for instance on a space mission.

In particular when the presence of multiple target compounds is expected or needs to be monitored it is common practice to collect target compounds on a solid adsorbent contained within a sampling device, such as a sampling tube. The material within the sampling device is then desorbed and analyzed in a suitable laboratory, which often involves gas chromatography (GC).

Desorption of analytes from an adsorbent is based on the principle that a previously adsorbed substance is released from the adsorbent at increasing temperatures. Desorption temperatures should be high enough to extract all analytes but should not be too high because that would increase a risk of generating artefacts from thermal degradation of the adsorbent.

A very suitable material for use as adsorbent in combination with thermal desorption is based on poly(2, 6-diphenyl-p-phenylene oxide), also known as poly(2, 6-diphenylphenol, PPPO or 3PO. In the present application this compound will be mostly referred to as PPPO. Products based on PPPO are commercially available. An example of this is the adsorbent product TENAX® of Buchem BV, the Netherlands, which is widely used as a column packing material for trapping volatiles from air (VOC) or liquids. The use of TENAX® has been specified in the standard methods of EPA, NIOSH, ISO 2011 16000-6 (Indoor air sampling), ISO 16017-1 (Sampling and analysis of VOC) and EN 14338:2004, EU Regulation No. 10/2011 (food simulant).

Since intermolecular binding forces are weak, the contaminants are easy to remove from the PPPO adsorbent. PPPO based adsorbents are particularly useful for the analysis of high boiling compounds such as alcohols, polyethylene glycols, diols, phenols, monoamines and diamines, ethanol amines, amides, aldehydes, ketones and chlorinated aromatics. Using thermal desorption equipment measurement on parts per billion (ppb) and parts per trillion (ppt) level is feasible.

Although currently available PPPO based adsorbents perform well, the inventors have observed that there is still room for improvement.

### SUMMARY OF THE INVENTION

In a first aspect the invention relates to a method for preparing porous adsorbent particles, comprising i) providing a solution of poly(2, 6-diphenyl-p-phenylene oxide) in an organic solvent medium; ii) bringing a droplet of said solution in a state wherein it is held aloft, without mechanical support via any physical contact; iii) evaporating said organic solvent medium while maintaining said solution in said state at least until the solution is converted into particles that are in semi-solid or solid state.

In a second aspect the invention relates to a PPPO based porous adsorbent particle, obtainable by the method of the first aspect of the invention.

In a third aspect the invention relates to a sampling tube, comprising a plurality of the porous adsorbent particles according to the second aspect of the invention.

In a fourth aspect the invention relates to the use of the porous particle according to the second aspect of the invention as an adsorbent in air collections. Accordingly, the invention relates also to the use of the sampling tube of the third aspect of the invention in air collections.

With the present invention PPPO based adsorbent particles are provided that have good accessible surface area, and a higher uniformity in pore size and distribution than prior art PPPO based material, which is indicative for improved adsorption properties. The prior art material namely has a very heterogeneous pore size distribution and irregular structure, and the present invention allows to provide monodisperse, uniform and precise pore arrays and particulate size. In particular, the method of the invention makes it possible to control the pore size and distribution which allows design of adsorbent particles to target specific classes of molecules to be adsorbed. In this regard it should also be mentioned that the present invention allows to prepare particles with very small pores, which can be used for adsorption of very small molecules, such as compounds selected from volatile organic compounds, C1-C5 hydrocarbons, such as CH₄, CO₂, CO. The porous adsorbent particles are thermally stable at high temperatures C or more.

### SHORT DESCRIPTION OF THE DRAWINGS

FIG. 1 shows a schematic diagram of the preparation of a particles according to the invention with a suspended drop of PPPO solution.

FIG. 2 shows the surfaces of a prior art PPPO adsorbent product with irregular shaped surface and pores (A) and the surface of a particle according to the invention with uniformly sized and distributed pore structures (B).

FIG. 3 shows an exemplary sampling tube according to the invention.

FIG. 4 shows SEM images of a PPPO particle produced from a 0.5 w/w % PPPO solution in DCM that has been exposed to a temperature of 375° C. Whole particles shown in the top images, zoomed section shown in the bottom images, no heat treatment and heat treatment at 375° C. under nitrogen atmosphere for 4 h shown on the left and right hand sides respectively.

FIG. 5 shows SEM images of a PPPO particle produced from a 5 w/w % PPPO solution in DCM that has been exposed to a temperature of 375° C. Whole particles shown in the top images, zoomed section shown in the bottom images, no heat treatment and heat treatment at 375° C. under nitrogen atmosphere for 4 h shown on the left and right hand sides respectively.

FIG. 6 shows porous arrays on a 20 μm×20 μm surface area of a particle produced from a 8 w/w % PPPO solution in DCM at a relative humidity (RH) of 60% (T=21° C.). FIG. 7 shows porous arrays on a 20 μm×20 μm surface area of a particle produced from a 5 w/w % PPPO solution in DCM at a RH of 10% (T=21° C.).

FIG. 8 shows porous arrays on a 20 μm×20 μm surface area of a particle produced from a 5 w/w % PPPO solution in DCM at a RH of 80% (T=21° C.).

FIG. 9 shows (a) SEM image series of surface structure of particles formed from binary mixtures of PPPO: DCM (5 w/w % PPPO) at 40% RH by drop levitation (T=21° C.) and (b) SEM image series of surface structure of a film from binary mixtures of PPPO: DCM (5 w/w % PPPO) deposited onto a glass slide at the same RH of the particles in (a) (T=21° C.).

FIG. 10 shows a SEM image series of surface structure of particles formed from levitation (T=21.C, RH=60%). Vertical images showing particles from binary mixtures of PPPO: DCM of increasing initial polymer concentration; 0.5, 3,5 and 8 w/w %. Horizontal SEM images show particles formed from ternary solutions of 5 w/w % PPPO, DCM and heptane, starting at 0 w/w % heptane, and increasing in initial heptane concentration; 4, 6, 10, 14, 16 w/w %. 5 FIG. 11 shows a 3D graph with the variables heptane concentration, PPPO concentration and RH being represented by the x, y and z axes respectively, and the point of intersection for the data sets being an initial binary solution concentration of 5 w/w % PPPO and RH %. Optical images 10 of final particles are displayed along the axes, and SEM micrographs are shown for some particles, showing trends in surface structure.

FIG. 12 shows a scheme for estimating particle surface area of the particles according to the invention. A) particle dimensions; B) image of particles showing that pores exist in layers within the skin; C) an image of a particle skin with pores visualized as multiple interconnected spheres.

### DETAILED DESCRIPTION OF THE INVENTION

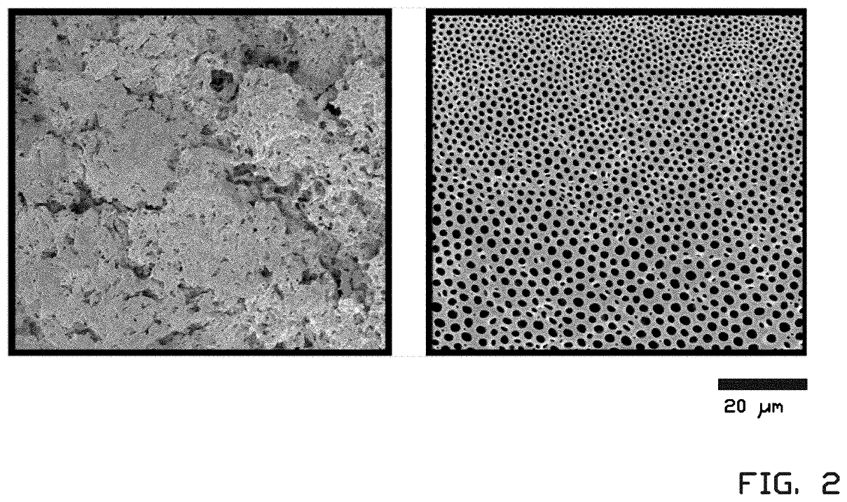

The present invention is based on the inventors' observation that porous PPPO particles with improved properties can be obtained when a droplet of PPPO dissolved in an organic solvent medium is brought in a state wherein it is held aloft, without mechanical support via any physical contact, and maintained in this state to allow the major portion of the solvent medium to evaporate. The inventors have found in particular that keeping the PPPO solution during evaporation of the solvent medium in a state wherein the solution is held aloft, without mechanical support via any physical contact, allows to design and obtain adsorbent particles with uniformly sized and distributed pore structures. This effect is clearly shown in FIG. 2 wherein FIG. 2A shows the surface of a prior art PPPO adsorbent product with irregular shaped surface and pores and wherein FIG. 2B shows the surface of a particle according to the invention with uniformly sized and distributed pore structures.

During drying of the polymer solution droplet, the resulting particle size, shape and surface structure can be controlled, with an emphasis on the reliable and predictive design of particles with uniform, specified morphology. In particular the invention allows to design and control pore size, ranging from very small to bigger pores in order to specifically to target the molecules to be adsorbed. In particular, the invention allows to prepare highly porous particles from polymer solutions with low concentrations of polymer, wherein the particles surprisingly do not collapse at exposure to high temperatures at 375° or more. Application of the adsorbent particles according to the invention are wide-ranging, in sensing/adsorbers.

The aforementioned state wherein the solution is held aloft, without mechanical support via any physical contact can in practice suitably be obtained by bringing the particles in a suspended state. In a practical embodiment bringing said solution in said state is affected by suspending said solution in air against gravity. To keep solution droplets in levitation this would require an upward force that cancels out the weight of the solution, so that the solution does not fall (accelerate downward) or rise (accelerate upward).

Although various techniques are available to bring and keep objects in a levitational state, in a practical embodiment suspending and maintaining said solution in air against gravity may take place by using a particle levitation technique, for instance by an acoustic levitation technique. Acoustic levitation is a method for suspending matter in air against gravity using acoustic radiation pressure from high intensity sound waves. Alternative drop suspension methods may be used within the context of the invention, such as spray dry techniques, as long as the suspended polymer solution is held aloft, without mechanical support via any physical contact.

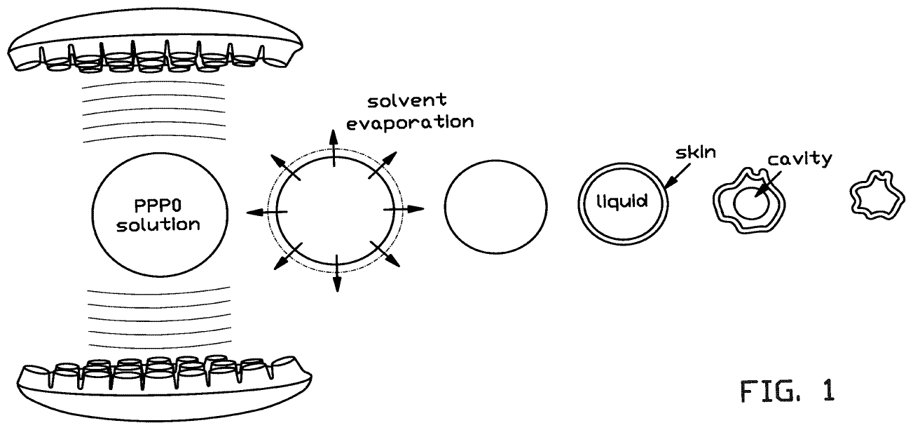

When particles are prepared in accordance with the invention during drying, polymer accumulates at the droplet surface, reaching a critical concentration and forming a gel-like skin at the interface. The core of the droplet, remains liquid for a while longer. Solvent continues to evaporate through the skin and, depending on the thickness and shear modulus of the skin, in due course a cavity is formed in the center of the drop. Cavity formation creates a pressure differential which, as the droplet further reduces its volume, initiates mechanical instabilities in the skin, resulting in a hollow particle, with an undulating surface structure. This process, is illustrated in FIG. 1 in which, as a non-limiting example, an acoustic levitator is used to prepare the particles according to the invention. FIG. 1 shows solvent evaporation, skin and cavity formation, and surface buckling. After drying by solvent evaporation over time, this eventually results in a polymer particle.

Evaporating said organic solvent while maintaining said solution in said state is carried at least until the solution is converted into particles that are in semi-solid or solid state. Once the particles are semi-solid or solid state the remaining liquid can be evaporated using conventional drying techniques without changing their structure and morphology. This makes the production process more efficient. Therefore, it is preferred that after step iii) particles are collected and subjected to a step iv) of drying. This drying step can suitably be performed by incubation of the collected particles in an oven.

During drying of the solution of PPPO in said organic solvent medium so-called self-assembly takes place. This is a spontaneous process which results in the formation of nano/micro-scale honeycomb structures (pore arrays) through the condensation of water droplets. The main physical processes involved in the process of forming these arrays typically include 1) evaporation of the polymer solution; 2) nucleation of water droplets; 3) condensation of water droplets; 4) growth of droplets; 5) rearrangement and stabilisation of droplets on the surface 6) evaporation of water; and 7) solidification of polymer which gives rise to a nano/micro-porous honeycomb pattern, termed a ‘breath figure’. The inventors have surprisingly found that these porous arrays on the generated particles can withstand high temperatures (up to 400° C.), without loss of the generated particles structure, despite being heated above the glass transition temperature. Typically, the current PPPO based adsorbents are used in this temperature range, meaning that the adsorbent particles according to the invention can withstand suitable temperatures for application whilst maintaining their fine structure. Best results are obtained the solution of PPPO in said organic solvent medium is provided in step i) in a concentration of at least 1 weight %, preferably at least 2 weight %, based on the weight of the solution. It is noted in this respect that wherever the annotation w/w % is used, this refers to the weight % of a given component based on the weight of the solution in which it is dispersed/dissolved.

The higher the concentration of PPPO in step i) is, the smaller the size and number of the pores in the particles are. On the other hand, when the concentration of the solution is very low, the particle skin formed whilst drying is very thin, and this may adversely affect the stability of the particles. In light of this, it is preferred that the solution of PPPO in the organic solvent medium is provided in a concentration of between 0.5% w/w and 20% w/w, with optimal concentrations between 2 and 8% w/w, such as between 3 and 7% w/w, such as between 4 and 6% w/w. Between these ranges a good balance is achieved between pore size and distribution and thus adsorption capacity on the one hand and increased thermal and mechanical stability on the other hand. It is further preferred in this respect that the solution of PPPO in said organic solvent medium is provided in a concentration of about 5% w/w.

The relation between the initial concentration of PPPO and the pore size and distribution also allows the design of particles to desired specifications with regard to pore size and distribution by varying the initial concentration of PPPO.

The solvent medium for the PPPO solution may be a medium comprising a single solvent or comprising a mixture of solvents.

Regarding the organic solvent medium for the PPPO solution good results have been obtained when the solution is based on dichloromethane (DCM). PPPO dissolves well in this solvent and it can be efficiently evaporated. Other solvents that may be used based on their polarity and evaporation characteristics may without limitation be selected from the group consisting of chloroform, toluene and tetrahydrofuran (THF). The inventors have observed that these solvents are capable of dissolving PPPO for the purpose of obtaining particles according to the invention.

The inventors have found that surface structure and morphology of particles can be further tailored by using non-solvent induced phase separation (NIPS), using a ternary system of PPPO, a good solvent and a non-solvent. A small amount of non-solvent may influence the pore size and distribution to a desired extent and can as such be applied to tailor a particle to desired specifications with regard to pore size and distribution. As a good solvent any of the solvents above may be used, and as a non-solvent for instance heptane can be used. A preferred combination solvent/nonsolvent for purposes of the present invention is DCM as solvent and heptane as non-solvent. Good results may be obtained with heptane concentrations of up to 6% w/w, such as from 4 to 6% w/w.

Bringing and maintaining said solution in levitational state can take place in an atmosphere with any relative humidity (RH), where it should be kept in mind that the RH has an effect on the size and distribution of the pores, as will be explained below. In this respect any RH between 0 and 100% is envisaged, such as between 10 and 80%. Increasing the RH of the atmosphere that the droplet was drying results in an increase in the extraction time but also results in a larger final particle size. In that sense also the RH can be applied to tailor structure and morphology of the adsorbent particles. Higher RH means more water is condensed on the surface of the droplet during drying, and this in conjunction with complex internal and external flows leads to some water being trapped inside the gel-like skin as it develops. The resulting pockets of water act in much the same way as the solvent-rich pockets, in that they provide support and prevent the skin from crumpling. As a result, the particles become increasingly porous at increasing RH. On the other hand, a broad range of RH is suitable for the purposes of the present invention as porous arrays are formed at RH as low at 10% or lower, and have pores of increasing size, irregularity of packing and polydispersity as RH increases. For very small pores an RH below 10%, such as between 0.1% and 10% may be used, to allow design of pores for C1-C2 hydrocarbon adsorption.

In a very suitable embodiment suspending and maintaining said solution in levitational state takes place in an atmosphere with a relative humidity between 50 and 70%, preferably around 60%. At these relative humidity levels a very good balance is achieved between pore size and distribution and thus adsorption capacity on the one hand and increased thermal and mechanical stability on the other hand.

The adsorbent particles can thus be designed to the wishes of the user by varying the initial concentration of the PPPO solution, the relative humidity of environment wherein evaporation takes place. Also the use of a nonsolvent so as to provide a ternary solution may be applied to tailor the morphology and surface of the PPPO adsorbent particles.

In accordance with the invention no additional heating needs to take place during steps ii) and iii) and the particle formation process may conveniently take place at room temperature. In this respect suspending and maintaining said solution in levitational state suitably takes place at a temperature of between 15 and 25° C., preferably at room temperature (20-25° C.), although heating may be applied.

As mentioned above, the method according to the invention results in porous adsorbent PPPO particles that are distinguishable from the prior art PPPO adsorbents in the sense that they have a higher uniformity in pore size and distribution than prior art PPPO based material, which is indicative for improved adsorption properties. In this respect the invention therefore also relates to a porous adsorbent PPPO particle, obtainable by the method according to the previous claims. In accordance with the above the particle of the invention may have a surface structure that comprises porous arrays.

In an embodiment the particle is a spheroid particle with a porous PPPO skin having a thickness between 30 and 50 μm. Such a particle can be obtained under the preferred method and conditions mentioned above and has good mechanical strength.

Pores may suitably have an apparent pore radius Rap of between 0.5 μm and 1 μm and/or an average pore spacing Rs between 0.4 μm and 1 μm, to achieve a good balance between pore size and distribution and thus adsorption capacity on the one hand and increased thermal and mechanical stability on the other hand.

In order to make the particles specifically suitable for adsorbing very small molecules, such as C1-C5 hydrocarbons, a lower apparent pore radius than 0.5 μm may be desirable, which may be designed by increasing the PPPO concentration and/or decreasing the RH and/or addition of a non-solvent, such as heptane.

The particles of the invention can be used as an adsorbent in air collections, in particular under high temperature circumstances in view of their improved thermal stability. In this respect the invention also relates to the use of the particle of the invention as adsorbent in air collections. In a particularly suitable embodiment the adsorbent particles of the invention can be used for adsorption of volatile organic compounds and/or C6-C26 hydrocarbons. On the other hand, the invention also provides particles that allow to trap very small molecules, if the particles are designed to have very small pore sizes. So, instead of a particle adsorbing a wide range of these molecules, specific morphology design of pore size and structure allows to prepare particles for specific molecules or a narrow distribution in the C1-C26 range to be targeted for trapping.

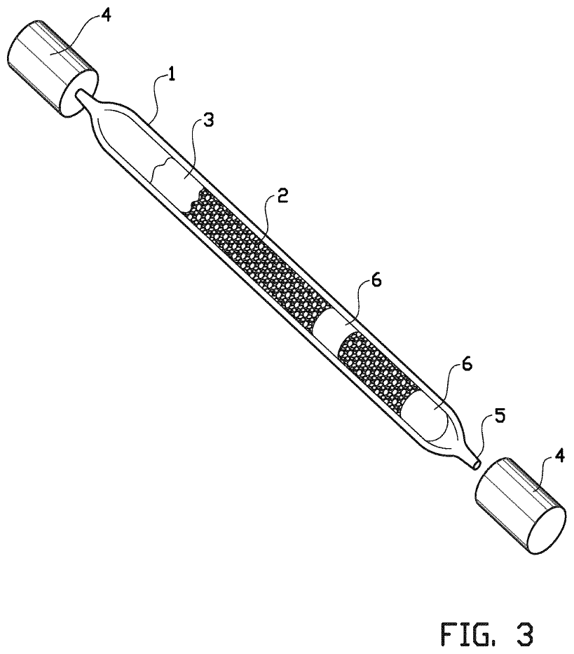

In a practical application of the invention the adsorbent particles of the invention are used in a sampling tube. Therefore the present invention also relates to a sampling device, comprising a plurality of the porous adsorbent particles according to the invention. In practice, a sampling tube is suitably used as a sampling device. An exemplary embodiment of such a tube is shown in FIG. 3. The sampling tube of FIG. 3 consists of a glass tube 1, containing an amount of adsorbent particles 2. In order to provide uniform pressure drop glass wool 3 and foam separators 6 may be used. Tips 5 of the tube may be precision sealed to allow safe and easy breaking to a desired opening size. Sealing caps 4 prevent contamination.

In a preferred embodiment the sampling tube is a thermal desorption (TD) tube. PPPO is a well-known adsorbent used in thermal desorption techniques. Moreover the high thermal stability of the particle material allows desorption at very high temperatures. This way full desorption of any adsorbed analytes is ensured without a risk of artefacts originating from thermal degradation of the adsorbent particles.

### EXAMPLES

The following examples are included to illustrate the invention and not to limit the scope of the claims.

### Example 1: General Preparation of Particles

This section includes a description of method steps and features that are applicable to all PPPO particle production routes. In the subsequent sections, alterations to specific parameters are included, to achieve certain structures.

### 1.1. Chemicals

Poly (2,6-diphenyl-p-phenylene oxide) (PPPO) (Mₙ reported between 11 and 250 kg/mol), Dichloromethane (DCM, VWR Chemicals, 99.9%, ρ=1.33 g/cm³) and heptane (VWR Chemicals, 99.8%, ρ=0.67 g/cm³) were used as solvent and non-solvent respectively.

### 1.2. Acoustic Levitation and Imaging

For the current experimental demonstration, a single-axis acoustic levitator, based on opposing arrays of ultrasonic transducers (TinyLev), was used for droplet drying experiments, all of which were carried out under controlled RH (RH chamber from Coy Labs, used in conjunction with an Electrotech Systems microcontroller). A horizontal tube microscope fitted with a 5× objective and a Basler acA2040-90uc camera was used for image acquisition, and the levitated droplets were backlit, to enhance image contrast. The small field of view of the camera was adjusted to align with the central pressure node of the standing wave, meaning polymer solution droplets could be precisely placed at the point they would be supported by the acoustic force, using a syringe. Images were acquired during drying at a rate of 1 FPS, over 5 minutes for polymer solution droplets, and pure solvent droplets for as long as complete evaporation. Images were analyzed using open source image analysis software (ImageJ). Dry polymer particles were coated in gold and imaged in a Zeiss Auriga Crossbeam scanning electron microscope (SEM).

### 1.3 Preparation of Particles According to the Invention

For the experiments shown in the present examples section the following general steps were conducted.
Step 1. At room temperature (21° C.) approx. 1.5×10⁻³ mL of PPPO in DCM solution is deposited, using a 1 mL HENKE-JECT syringe and 23 gauge needle, and suspended.
Step 2. The solutions are suspended for 5 minutes in the field to allow for sufficient removal of DCM to ensure the particle is concentrated into at least in a ‘gel-like’ i.e. semi-solid state, and the structure does not evolve further.
Step 3. Additional solvent removal beyond this point is very slow, particles are collected in a glass vial (but not sealed, as solvent is still leaving), and are left for at least 24 hours to dry.
Step 4. The ‘dry’ particles at this point will still contain some trapped DCM, and so are placed in an oven at 40° C. for around 12 hours, to facilitate additional solvent removal (DCM boiling point is 39.6° C.).

### Example 2. Particles Prepared with a Low Concentration of PPPO (Heat Treatment)

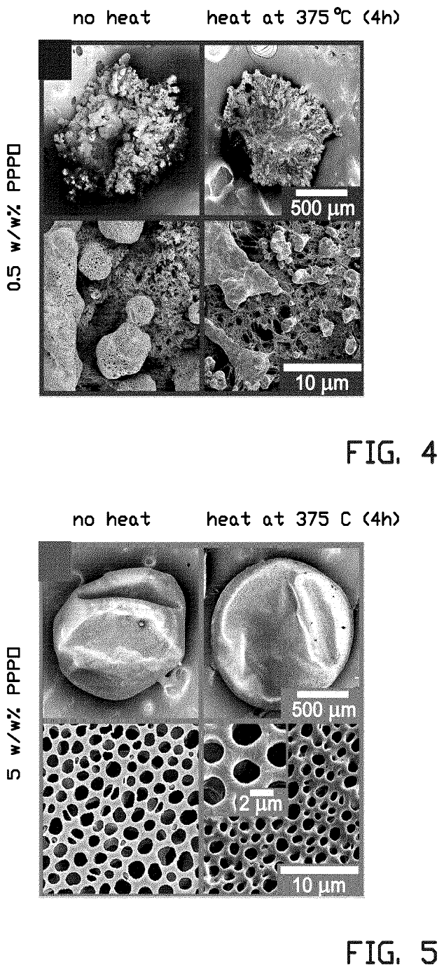

For this example, particles were produced from a 0.5 w/w % PPPO solution in DCM. The relative humidity of the atmosphere is set at 60%, for room temperature (21° C.). Approximately 1.5×10⁻³ mL of PPPO in DCM solution, with a concentration of 0.5 w/w %, was suspended. FIG. 4 shows SEM images of these particles. The particles prepared this way have a in “coral” like morphology as shown in the left panels of FIG. 4. Whole particles are shown in the top images, and a zoomed section is shown in the bottom images.

When the particles were exposed to heat treatment at 375° C. under nitrogen atmosphere for 4 h it appeared that the particle structure could not withstand this thermal treatment because the structure of the particles changes significantly as can be seen by comparing the left panels (no heat treatment) with the right panels (heat treatment).

The 0.5 w/w % particle in FIG. 4 before heat treatment had a very intricate structure which seems to consist of a series of surface undulations: the concave portions of the surface are thin folds of crumpled, papery polymer, and the convex portions are comprised of a ‘coral’-like structure. The fine details of these structures are lost after heating, small pores remain on the ‘coral’ areas as the openings have clearly plasticized considerably before crystallization. Conversely in the concave areas the openings have become larger, as the very thin polymer matrix has broken and merged as it plasticized to leave a ‘chewing gum’ structure. The particle itself looks deflated and collapsed.

### Example 3. Particles Prepared with a 5% w/w Concentration of PPPO (Heat Treatment)

For this example, particles were produced from a 5 w/w % PPPO solution in DCM. Further conditions were as described for Example 2.

FIG. 5 shows SEM images of these particles. Whole particles are shown in the top images, and a zoomed section is shown in the bottom images. As can be seen in the lower left panel of FIG. 5 particles are obtained with a surface containing porous arrays. When the particles were exposed to heat treatment at 375° C. under nitrogen atmosphere for 4 h it appeared that the particle structure could withstand this thermal treatment because the structure of the particles did not change significantly as can be seen by comparing the left panels (no heat treatment) with the right panels (heat treatment). The 5 w/w % polymer on the other hand has a structure that is almost unchanged (FIG. 5). The pore sizes are approximately the same size before and after heating—if perhaps slightly smaller after heating due to some plasticization. Clearly, the thicker polymer skin as a result of the higher concentration of PPPO was apparently robust enough to retain its structure for long enough to allow crystallization to take place. Thus, of the particles that were exposed to heat treatment at 375° C. under nitrogen atmosphere for 4 h morphology did not change much during this thermal treatment, indicating that these particles are able to withstand high temperatures for a long duration.

### Example 4

For this example, particles were produced from a 8 w/w % PPPO solution in DCM. The relative humidity of the atmosphere is set at 60% at room temperature (21° C.). Approximately 1.5×10⁻³ mL of PPPO in DCM solution, with a concentration of 8 w/w %, was suspended.

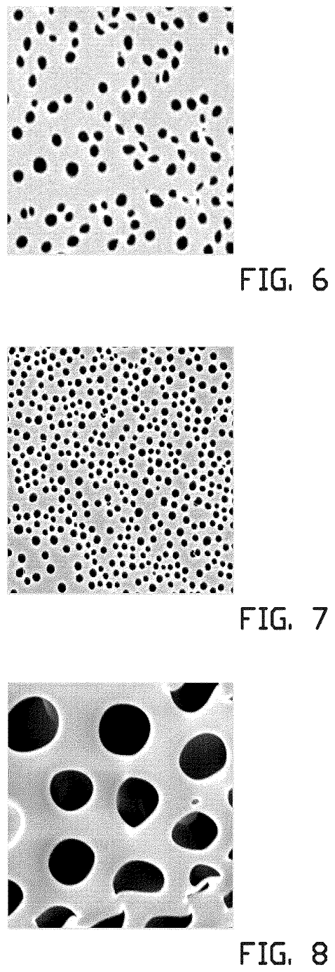

This resulted in particles with a porous arrays structure as seen in FIG. 6 which shows porous arrays on a 20 μm×20 μm surface area of a particle. As can be seen in FIG. 6, the pores are uniform in size but not closely packed.

### Example 5

For this example, particles were produced from a 8 w/w % PPPO solution in DCM. The relative humidity of the atmosphere is set at 10% at room temperature (21° C.). Approximately 1.5×10⁻³ mL of PPPO in DCM solution, with a concentration of 5 w/w %, was suspended.

This resulted in particles with a porous structure as seen in FIG. 7 which shows porous arrays on a 20 μm×20 μm surface area of a particle. As can be seen in FIG. 7, the pores are relatively small compared to the pores of the particles of example 4 (FIG. 6).

### Example 6

For this example, particles were produced from a 5 w/w % PPPO solution in DCM. The relative humidity of the atmosphere is set at 80% at room temperature (21° C.). Approximately 1.5×10⁻³ mL of PPPO in DCM solution, with a concentration of 5 w/w %, was suspended.

This resulted in particles with a porous arrays structure as seen in FIG. 8 which shows porous arrays on a 20 μm×20 μm surface area of a particle. As can be seen in FIG. 8, the pores are relatively large compared to the pores of the particles of example 4 and 5 (FIGS. 5 and 6).

The results of examples 4, 5 and 6 show that the relative humidity and initial PPPO concentration affect the eventual morphology of the particles and as such can be used to tailor the particles to the desired specifications.

It was also observed that increasing the initial PPPO concentration of the droplet resulted in an increase in the extraction time and final particle size. As PPPO concentration is increased the concentration of accumulated polymer on the surface of the droplet becomes higher and creates a thicker skin that is more resistant to deformation—the total extraction time of solvent also then increases with PPPO concentration due to this thick skin limiting diffusion.

### Example 7. Comparison Between Particles and Adsorbent Material Formed as Films

Particles prepared according to the invention were compared to adsorbent material produced from films. For this purpose, particles according to the invention were prepared from a 5 w/W % PPPO solution in DCM. The relative humidity of the atmosphere is set at 80% at room temperature (21° C.). Approximately 1.5×10⁻³ mL of PPPO in DCM solution, with a concentration of 5 w/w %, was suspended and prepared as described above in example 1.

On the other hand, in order to prepare adsorbent material from films from 5 w/w % PPPO: DCM solutions were drop cast on a glass microscope cover slip, and allowed to dry under at 40% RH. The dry films were coated in gold and imaged in a Zeiss Auriga Crossbeam scanning electron microscope (SEM).

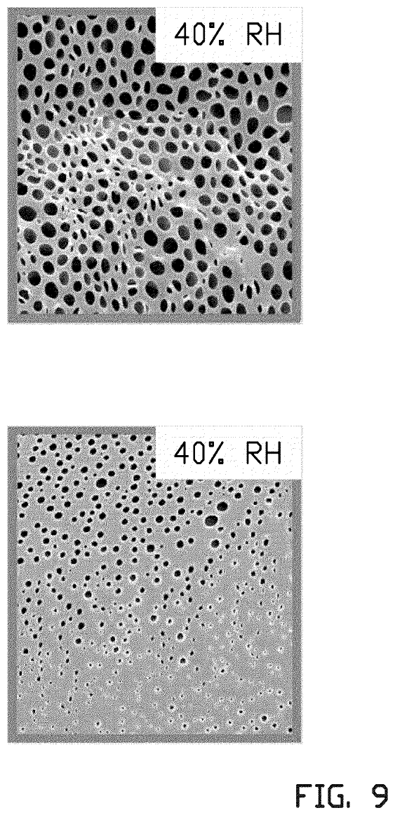

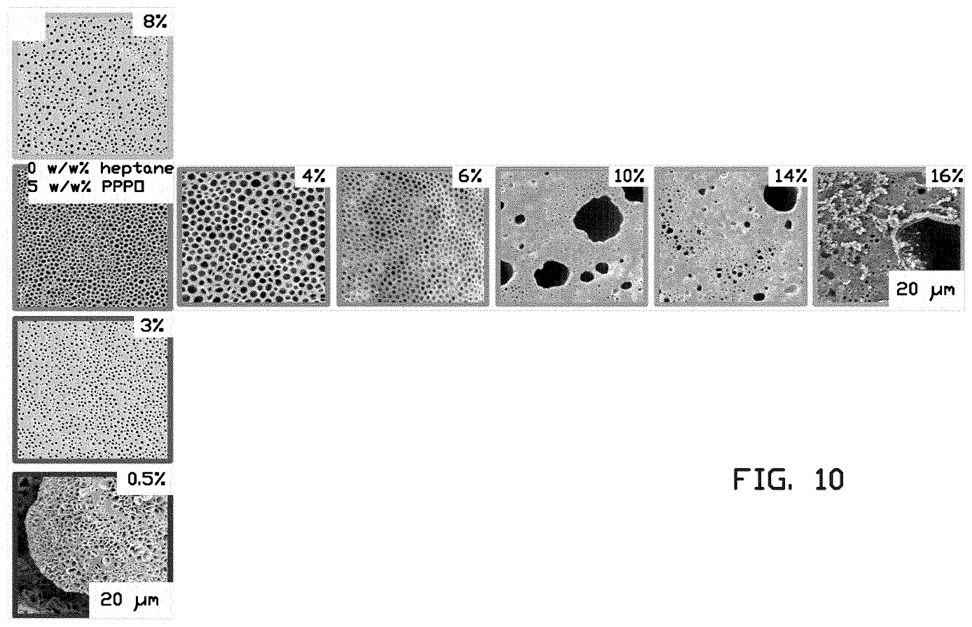

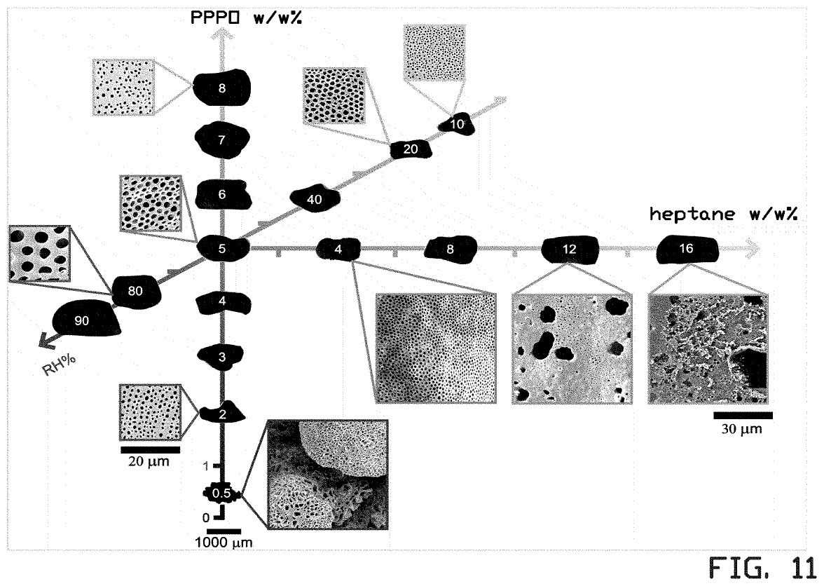

FIG. 9 shows SEM images of the porous arrays on the surfaces of particles (A). As can be seen in FIG. 9 a porous arrays are formed, which are uniform in size and relatively uniformly and closely packed. On the other hand, when the polymer solution is drying as a film, under these conditions the pores are less uniform in size less uniformly packed as can be seen in FIG. 9B. It is noted that pores formed at higher RH (60, 80 and 100%) are very similar in size, shape and packing for both particles and the corresponding deposited films (not shown), but even so the film of adsorbent material is not very suitable for the primary intended use in a sampling tube.

### Example 8. Use of a Non-Solvent in the PPPO Solution

In this example the use of a non-solvent, heptane, was tested in the PPPO solution. The surface structure of particles formed from binary PPPO: DCM and ternary PPPO: DCM: heptane solutions is shown in SEM images in FIG. 10. The compositions are indicated in the top right corner of each image, vertically (increasing PPPO) and horizontally (increasing heptane). Firstly, the structures from binary solutions (top to bottom, particularly at higher concentrations, comprise of cellular cavities that do not appear to be interconnected. As no non-solvent was present during drying, the porous arrays must be the source of this porosity. As mentioned above the pores on the lowest concentration (0.5 w/w % PPPO) particle are less isotropic in shape and appear less uniform in size, resulting in a ‘coral-like’ structure. The pores formed from higher concentrations of PPPO (3, 5 and 8 w/w % PPPO solution) seem to have a wider, more random spacing.

Particles from ternary mixtures of PPPO: DCM: heptane, the structure at low initial heptane concentrations (4 and 6 w/w %) does not appear to have been formed by demixing—the small uniform cells are characteristic of breath figure formation. Therefore, by examining surface structure alone, it would appear that these small quantities of non-solvent are not sufficient to cross the phase boundary during drying. It appears that using this ternary system the initial skin formation happens early, and breath figures are the dominant structure as the skin does not reach a concentration within the two-phase region, but the change in the internal composition is then dependent on the ability of each solvent to diffuse through the gel-like PPPO skin. In this case, it appears that the heptane is greatly restricted by the PPPO skin, so that the internal liquid composition of the drying drop undergoes NIPS. Higher heptane compositions (above 6% w/w) form typical demixed structures with large pores and less uniformity and, at the highest compositions, nodular surface.

The particle size for the solutions containing heptane also increases with initial heptane concentration, although for a different reason. As DCM evaporates several times more quickly than heptane, the concentration inside the polymer solution drop may as some point cross into the two-phase region and begin to demix—particularly close to the interface as there is a higher accumulation of polymer here. This phase separation will result in pockets of solvent-rich phase, which will evaporate and form air pockets that will effectively bolster the polymer skin and prevent the particle from crumpling—resulting in a larger final particle. In addition, the extraction time decreases with the addition of heptane, as these pockets of solvent-rich phase close to the surface will evaporate more quickly as they contain less polymer.

### Example 9

The above examples show the formation of PPPO particles in suspension.

A range of particle morphologies, sizes, skin thickness, surface structures, and degrees of surface porosity, are controllably formed by varying the polymer concentration, heptane concentration and by using RH to induce pore formation. The disclosure below and FIG. 11 show a summary of the findings in this respect.

Increasing the initial PPPO concentration of the droplet resulted in an increase in the extraction time and final particle size. As PPPO concentration is increased the concentration of accumulated polymer on the surface of the droplet becomes higher and creates a thicker skin that is more resistant to deformation.

FIG. 11 shows SEM imaging of particles from binary PPPO solutions which show pore formation on the surface of all particles, even to a certain extent on the particles prepared with a starting solution of 0.5% w/w PPPO.

FIG. 11 also shows that demixed structure is seen on the polymer surface above 6 w/w % heptane concentration—below this, porous arrays are seen on the surface.

As shown further in FIG. 11, pores were formed on levitated drops at RH as low at 108, and have pores of increasing size, irregularity of packing and polydispersity as RH increases.

### Example 10. Estimating Particle Area

In the following example an estimation of the surface area of a particle according to the invention is made as evidence of the high adsorption capacity of the particle according to the invention.

For this purpose, the particle of FIG. 5 (example 3) is taken as a model.

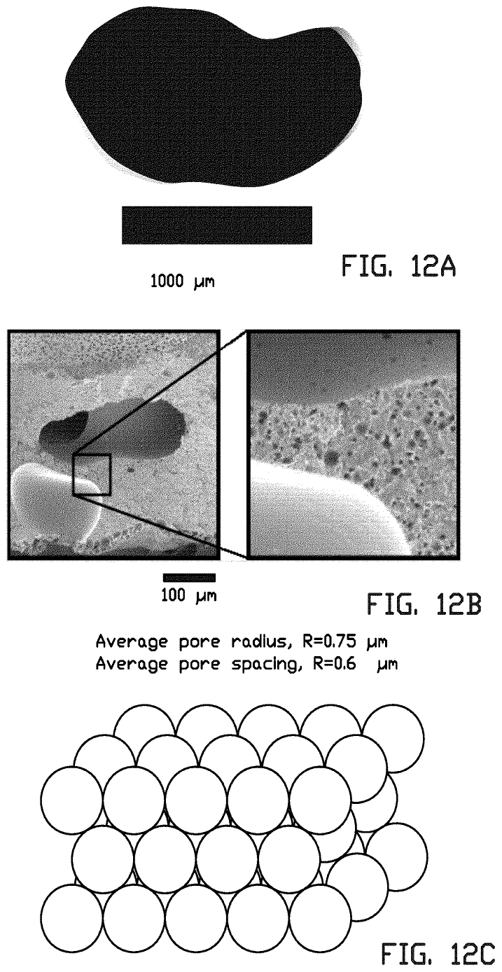

The particle dimensions are determined by modelling the final particle as shown in FIG. 12A as an approximate oblate ellipsoid; assuming no pores the surface area of an average particle formed at 5 w/w % PPPO is ~3200000 μm². The measured skin thickness is 40 μm.

Based on the SEM images as shown in FIG. 5 the average pore radius is estimated at R=0.75 μm and the average pore spacing is estimated at R_{S}=0.6 μm.

Assuming each pore is a cylinder, with a length that corresponds to the skin thickness of the particle (40 μm). The average pore circumference is 2×π×0.75=4.71 μm. The average pore area is 4.71×40=188.50 μm². The measured pore coverage is 47%, therefore the ‘void space’ 53%. The approximate particle surface area is therefore: (3200000×0.53)+(3200000×0.47×188.5)=285000000 μm², meaning a surface increase of a factor of around 90.

Alternatively, assuming the pore is a sphere and taking an average apparent pore radius of R=0.75 μm and an average pore spacing of R_{S}=0.6 μm. The average pore internal area will then be 32.52 μm².

The measured pore coverage is 47%, therefore the void space′ 53%. The approximate particle surface area is therefore: (3200000×0.53)+(3200000×0.47×32.52)=50600000 μm². This would imply a surface area increase of a factor of around 15.8.

In further reference to this, from FIG. 12B, it is clear that the pores exist in layers within the skin. Assuming now a particle with a skin thickness of 40 μm and a pore diameter of approximately 2 μm, and assuming that the pores in the skin are interconnected spheres in multiple layers of spheres, as schematically shown in FIG. 12C, this would lead to the following figure:

TABLE 1
estimated surface area increase in particles
according to the invention.

| Number of | Available adsorption | Surface area |
|---|---|---|
| layers | area (μm²) | increase factor |
| 5 | 468800000 | 146.5 |
| 10 | 928300000 | 290.1 |
| 20 | 1847300000 | 577.3 |

By modelling the pores as either cylinders or spheres, a surface area increase factor of between 90.0 and 577.3 can be obtained when particles are prepared in accordance with example 3, further tailoring in accordance with the disclosure of the present application may even result in higher surface area increase factors.

1. A method for preparing porous adsorbent particles, comprising
i) providing a solution of poly(2,6-diphenyl-p-phenylene oxide) in an organic solvent medium;
ii) bringing a droplet of said solution in a state wherein it is held aloft, without mechanical support via any physical contact;
iii) evaporating said organic solvent medium while maintaining said solution in said state at least until the solution is converted into particles that are in semi-solid or solid state.

2. The method according to claim 1, wherein bringing said solution in said state is effected by suspending said solution in air against gravity.

3. The method according to claim 2, wherein suspending and maintaining said solution in air against gravity takes place by using particle levitation technique.

4. The method according to claim 1, wherein said particle levitation technique is an acoustic levitation technique.

5. The method according to claim 1, wherein the solution of poly(2,6-diphenyl-p-phenylene oxide) in said organic solvent medium is provided in a concentration of between 0.5 and 20% w/w.

6. The method according to claim 5, wherein the solution of poly(2,6-diphenyl-p-phenylene oxide) in said organic solvent medium is provided in a concentration of at least 1% w/w.

7. The method according to claim 6, wherein the solution of poly(2,6-diphenyl-p-phenylene oxide) in said organic solvent medium is provided in a concentration of between 1% w/w and 8% w/w.

8. The method according to claim 7, wherein the solution of poly(2,6-diphenyl-p-phenylene oxide) in said organic solvent medium is provided in a concentration of about 5% w/w.

9. The method according to claim 1, wherein the solvent medium is a dichloromethane based solvent medium.

10. The method according to claim 9, wherein the solvent medium also contains heptane in a concentration of up to 6% w/w.

11. The method according to claim 1, wherein bringing and maintaining said solution in said state takes place in an atmosphere with a relative humidity between 10 and 80%.

12. The method according to claim 11, wherein suspending and maintaining said solution in said state takes place in an atmosphere with a relative humidity between 50 and 70%, preferably around 60%.

13. The method according to claim 1, wherein suspending and maintaining said solution in said state takes place in an atmosphere with a relative humidity below 10%.

14. The method according to claim 1, wherein suspending and maintaining said solution in said state takes place at a temperature of between 15 and 25° C., preferably at room temperature (20-25° C.).

15. The method according to claim 1, wherein after step iii) particles are collected and subjected to
iv) drying.

16. The method according to claim 15, wherein step iv) is performed by incubation of the collected particles in an oven.

17. A porous adsorbent particle, obtainable by the method according to claim 1.

18. The porous adsorbent particle according to claim 17, having a particle surface with porous arrays.

19. The porous adsorbent particle according to claim 17, which is a spheroid particle with a porous poly(2,6-diphenyl-p-phenylene oxide) skin having a thickness between 30 and 50 μm.

20. The porous adsorbent particle according to claim 17, wherein said pores have an apparent pore radius Rₐₚ of between 0.5 μm and 1 μm.

21. The porous adsorbent particle according to claim 17, wherein said pores have an average pore spacing Rₛ between 0.4 μm and 1 μm.

22. An air sampling device, comprising a plurality of the porous adsorbent particles according to claim 17.

23. The air sampling device according to claim 22, which is a thermal desorption (TD) tube.

24. A method for collecting target airborne compounds from air suspected of containing said target airborne compounds, said method comprising passing said air in contact with porous particles as claimed in claim 17.

25. The method of claim 24, wherein the porous particles absorb volatile organic compounds and/or C1-C26 hydrocarbons from the air.

26. The method of claim 24, wherein the porous particles absorb one or more selected from volatile organic compounds, C1-C5 hydrocarbons, such as CH₄, CO₂, CO from the air.
